(19) United States
(12) Patent Application Publication
(10) Pub. No.: US 2006/0085736 A1
(43) Pub. Date: Apr. 20, 2006

(54) A Scientific Formula and System which derives standardized data and faster search processes in a Personnel Recruiting System, that generates more accurate results

(76) Inventor: Anthony S. Au, Vancouver (CA)

Correspondence Address: JEFFREY FURR, 253 N. MAIN STREET, JOHNSTOWN, OH, 43031, US

(21) Appl. No.: 10/711,972

(22) Filed: Oct. 16, 2004

(51) Int. Cl. G06F 17/24; G06F 17/21

(52) U.S. Cl. 715/513

(57) ABSTRACT

The present invention relates to a data processing system, engrained with value-added methodologies to create a highly structured and automated recruiting system. This system may reduce the time required to select a meaningful shortlist, as well as improving the compatibility of qualifications of candidates towards the requirements of a position. In doing so, the savings may result in reduction of both tangible and intangible costs currently incurred by an employer-company today.

### BACKGROUND

1. Field of the Invention

The present invention relates to a data processing system with know-how and methodology to create an automated recruiting system, based on logical and systematic matching of standardized and structured data related to requirements of a position of a company (looking for an employee), and work experience and qualifications of a candidate (looking for an employer).

2. Description of Prior Art

Traditionally, recruiting requires constant interaction by individuals on both sides of the meeting table. This dynamic (human) interaction is of particular importance for senior management positions, say, at top levels of an organization and their first-line reports, where the matching process is often based on intangible, unique (to a particular management situation) and variable factors.

At the most senior management levels, recruitment will likely continue to be conducted with an evaluation process that revolves around constant interaction, based on real time interface between two parties.

But apart from the senior levels, recruitment of middle management and general staff positions, given their more prevalent responsibilities, are more reliant on common and standard data, through a matching process that requires less real time interaction. Recruitment at these levels are hence, more susceptible to automation.

To-date, automation on recruitment is predominantly represented by a passive display of static information on electronic poster boards similar in format and process to an electronic newspaper. The application of keyword searches is limited to a one-dimensional directory of data reference. Little value-add applications to the recruitment process are available in the recruiting automation services offered in the market today.

In addition, recruitment systems today often are matching ‘apples’ to ‘oranges’, due to the inconsistency of information supplied in the resumes of candidates and those requested in position specifications of hiring companies.

Until more relevant and consistent information can be captured, automated systems for recruitment will be confined to a simple display of limited, lower level positions, where relatively simple requirements can be standardized in a compatible format between the two parties involved in the recruitment process.

### PRIOR ART

U.S. Pat. No. 6,754,874 by Richman and issued on Jun. 22, 2004, is for a computer-aided system and method for evaluating employees. It discloses a computer-aided method of evaluating personnel performance. The method includes the steps of making available to a user an electronic evaluation form, inputting a first set of data into the electronic form corresponding to the user, submitting the form including the first set of data for review to a second user and inputting a second set of data into the electronic form corresponding to the second user.

U.S. Pat. No. 6,662,194 by Joao and issued on Dec. 9, 2003, is for an apparatus and method for providing recruitment information. It discloses an apparatus and method for providing recruitment information, including a memory device for storing information regarding at least one of a job opening, a position, an assignment, a contract, and a project, and information regarding a job search request, a processing device for processing information regarding the job search request upon a detection of an occurrence of a searching event, wherein the processing device utilizes information regarding the at least one of a job opening, a position, an assignment, a contract, and a project, stored in the memory device, and further wherein the processing device generates a message containing information regarding at least one of a job opening, a position, an assignment, a contract, and a project, wherein the message is responsive to the job search request, and a transmitter for transmitting the message to a communication device associated with an individual in real-time.

U.S. Pat. No. 6,615,182 by Powers, et al. and issued on Sep. 2, 2003, is for a system and method for defining the organizational structure of an enterprise in a performance evaluation system. It discloses an organizational structure of an enterprise is defined in a performance evaluation system by storing a plurality of user-defined levels. A user-defined hierarchy is stored for the levels.

U.S. Pat. No. 6,385,620 by Kurzius, et al. and issued on May 7, 2002, is for a system and method for the management of candidate recruiting information. It discloses a system for automated candidate recruiting using a network includes a candidate web engine operable to communicate with the network and to present a candidate survey form to a client of the network, the candidate web engine further operable to receive candidate qualification data from the client that is entered in the form.

U.S. Pat. No. 6,381,592 by Reuning and issued on Apr. 30, 2002, is for a candidate chaser. It discloses a machine and method that automatically locate Internet site pages and web postings which contain operator specified keywords or Boolean combinations and then extracts all electronic mail addresses from those pages as well as hyper-linked pages to as many linking levels as selected by the operator and then sends a job opportunity description in the form of an electronic mail message to each of the extracted addresses then receives responses from recipients of the job opportunity message then filters those messages by reading their text and forwards only desired responses to the candidate seeking client's electronic mail address thusly sparing the client interaction with large amounts of irrelevant response while presenting viable candidates for a given job opening.

U.S. Pat. No. 6,370,510 by McGovern, et al. and issued on Apr. 9, 2002, is for an employment recruiting system and method using a computer network for posting job openings and which provides for automatic periodic searching of the posted job openings. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 6,363,376 by Wiens, et al. and issued on Mar. 26, 2002, is for a method and system for querying and posting to multiple career websites on the internet from a single interface. It discloses a method and system for querying multiple career websites from a single interface is disclosed, where each of the websites comprises a plurality of web pages having site-specific fields requiring input of data. The method and system include collecting information from a user, and mapping the user information to the site-specific fields of each of the career websites.

U.S. Pat. No. 5,991,595 by Romano, et al. and issued on Nov. 23, 1999, is for a computerized system for scoring constructed responses and methods for training, monitoring, and evaluating human rater's scoring of constructed responses. It discloses systems and methods for presentation to raters of constructed responses to test questions in electronic workfolders.

U.S. Pat. No. 5,978,768 by McGovern, et al. and issued on Nov. 2, 1999, is for a computerized job search system and method for posting and searching job openings via a computer network. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 5,884,270 by Walker, et al. and issued on Mar. 16, 1999, is for a method and system for facilitating an employment search incorporating user-controlled anonymous communications. It discloses a system for facilitating employment searches using anonymous communications includes a plurality of party terminals, a plurality of requestor terminals, and a central controller.

U.S. Pat. No. 5,758,324 by Hartman, et al. and issued on May 26, 1998, is for a resume storage and retrieval system. It discloses a method of and apparatus for storage and retrieval of resume images in a manner which preserves the appearance, organization, and information content of the original document. In addition, summaries or “outlines” of resume images, broken down into multiple fields, are stored, and can be searched field by field.

U.S. Pat. No. 5,671,409 by Fatseas, et al. and issued on Sep. 23, 1997, is for a computer-aided interactive career search system. It discloses a method for accessing career information located in a computer database through interactive CD-ROM technology or other suitable computer-accessible means. The method involves the use of several levels of inquiry from which a user can select various careers, and for each career ask specific questions.

U.S. Pat. No. 5,164,897 by Clark, et al. and issued on Nov. 17, 1992, is for an automated method for selecting personnel matched to job criteria. It discloses an automated method for selecting personnel which includes the step of selecting a first set of employees having qualifications matching a first job criterion from a first data file where the first data file includes a first plurality of records and each record includes a first job selection criterion, such as job titles, and a corresponding employee code. A second step comprises selecting a second plurality of employees having qualifications matching a second job criteria from a second data file which includes a second plurality of records wherein each record includes a second job selection criteria, such as industrial experience, and a corresponding employee code.

The need for a better method for recruiting personnel in a manner that gives good matches to a company shows that there is still room for improvement within the art.

1. Field of the Invention

2. Description of related art including information disclosed under 37 CFR § 1.97**> and 1.98<.

### SUMMARY OF THE INVENTION

The present invention relates to a data processing system, engrained with value-added methodologies to create a highly structured and automated recruiting system. This system may reduce the time required to select a meaningful shortlist, as well as improving the compatibility of qualifications of candidates towards the requirements of a position. In doing so, the savings may result in reduction of both tangible and intangible costs currently incurred by an employer-company today.

The invention will reduce a substantial amount of time of conventional methods of recruitment, while increasing the accuracy in matching candidates with positions, at a fraction of the cost currently incurred by companies today.

The process is more efficient, effective, accurate and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows a sample of the data;

FIG. 3 shows the match up of the data;

FIG. 4 shows the data is scored;

FIG. 5 shows the winning attributes being scored;

FIG. 6 shows the character attributes being scored; and

FIG. 7 shows the system's data security measures.

### DESCRIPTION OF THE PREFERRED EMBODIMENT

There are a number of significant design features and improvements incorporated within the invention.

The present invention relates to a data processing system 1, engrained with value-added methodologies to create a highly structured and automated recruiting system. This system 1 may reduce the time required to select a meaningful shortlist, as well as improving the compatibility of qualifications of candidates towards the requirements of a position. In doing so, the savings may result in reduction of both tangible and intangible costs currently incurred by an employer-company today.

The system 1 is set to run a on a computing device 10. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a stand alone system.

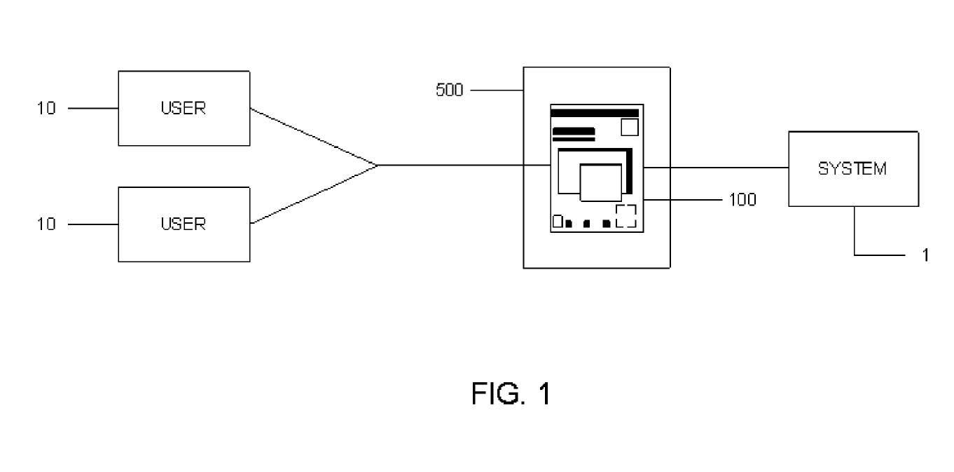

As shown in FIG. 1, the users 10 would access the system 1 through a network 100 or Internet 500. The system's software would reside in the system's memory 310. There are a number of different components of the system 1, these are described below.

The system 1 uses a memory means such as a standard hard drive or any other standard data storage device to store the data.

The standardized data is a glossary, master reference of 4 sets of data (Goals, Responsibilities, Personal/Character Attributes, Winning Attributes), in standardized terminologies with singular meanings, for both companies and candidates, are compiled for each position being recruited.

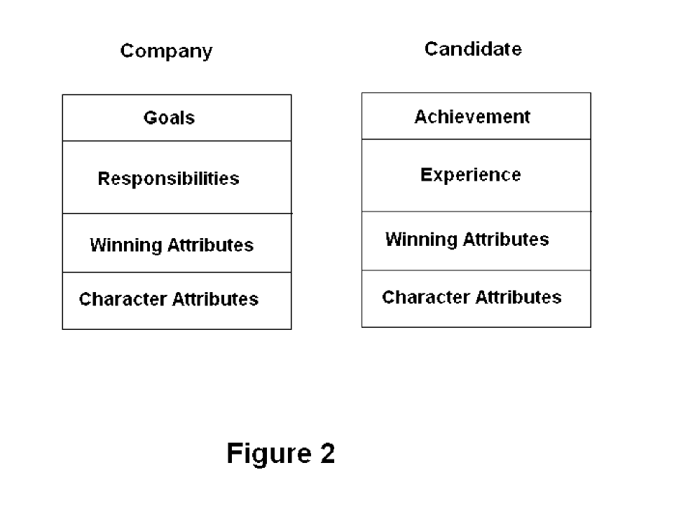

As shown in FIG. 2, the 4 sets of data, on the companies' side, are organized in a top-down, goal-oriented structure, to drive out qualifications required in a position to be recruited, in the following order:

Goals (set for each position);

Responsibilities (required to achieve each set goal);

Personal/Character Attributes (needed to discharge defined goals and responsibilities); and

Winning Attributes (additional qualifications needed to discharge defined goals and responsibilities).

Also as shown in FIG. 2, on the candidates' side, corresponding data are organized in a similar structure, as follows:

Achievements summarized from each position over the career of a candidate;

Experience/Responsibilities summarized for each position over the career of the candidate;

Winning Attributes summarized from each position over the career of the candidate; and

Personal attributes of the candidate.

For the guided compilation of the data, the procedure of the current invention has the data entered in the following order.

For the companies, goals are entered for each position with no more than 3 goals are allowed for each position. Responsibilities are entered for each goal entered, with no more than 5 responsibilities allowed for each goal. Personal/character attributes appropriate for the position are entered with no more than 8 character attributes allowed for each position. Winning attributes required for the position are entered, with no more than 8 winning attributes allowed for each position.

For the candidates, responsibilities are entered for each position over a career with no more than 5 responsibilities allowed for each position. When all responsibilities of all positions over a career have been entered, the candidates select the 8 most proficient responsibilities/skills. Achievements are entered for each position over a career with no more than 3 achievements allowed for each position. When all achievements over a career have been entered the candidates select the 5 most notable achievements within the last 10 years from current date. The candidate's self profiling character attributes are entered with no more than 8 character attributes allowed for each candidate. Winning attributes are entered for each position over a career, with no more than 8 winning attributes allowed for each position. When all winning attributes over a career have been entered, the candidates select the 8 most notable winning attributes within the last 10 years from the current date.

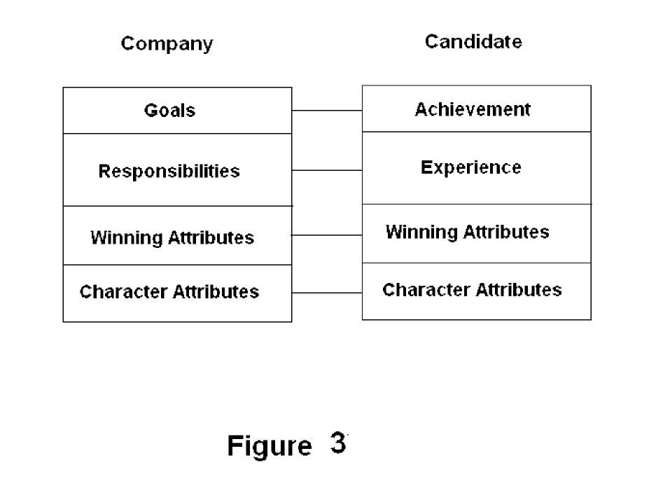

The system 1 uses programs run by the computer processor to form a matching process as shown in FIG. 3. The company's requirements are matched with candidate qualifications in the following categories.

“Gateway” Requirements which are basic prerequisites for a position that will need to be fulfilled before any further matching is conducted, including: Academic qualifications (e.g. a university degree); Professional/vocational qualifications (e.g. Chartered Accountant, JAVA programmer); and Language (e.g. English).

The system 1 matches up to 3 goals of a position, as defined by the Company. These are matched with 5 summary achievements claimed by a candidate over the most recent 10 years of his/her career, as defined by the candidate.

The system 1 matches the responsibilities of the position using up to 15 responsibilities, as defined by the Company, required to achieve goals set for a position are matched with the 8 most proficient responsibilities/skills described by a candidate.

The system 1 matches the character attributes for a position using up to 8 character attributes, as defined by the Company that are matched with up to 8 attributes provided by the candidate in his/her self profiling.

The system 1 matches the winning attributes for a position using up to 8 winning attributes, as defined by the Company that are matched with up to 8 attributes provided by the candidate.

The limitations of a one-dimensional directory of data (key-word) reference is improved by the application of fuzzy logic, as defined in the industry, in the matching of entire phrases/statements (e.g. to identify/develop/maintain customer relationships . . . ) and in the matching within context (e.g. ‘independent’ as a character attributes, as opposed to ‘independent dealers channel’ . . . ). Some of the fuzzy logic processes are disclosed in the following texts which are incorporated by reference, Artificial Intelligence by M. Negnevitsky, Fundamental of Neural Networks by L. Fausett, Genetic Algorithms by D. E. Goldberg and Machine Learning by T. M. Mitchell. The present invention uses some of the principles of fuzzy logic as published by L. A. Zadeh and discussed in U.S. Pat. No. 5,167,005 to Yamakawa filed on Aug. 11, 1989, U.S. Pat. No. 5,179,625 to Hisano filed on May 5, 1992, U.S. Pat. No. 5,724,488 by Prezioso and U.S. Pat. No. 5,577,169 also by Prezioso which are herein incorporated by reference in their entirety

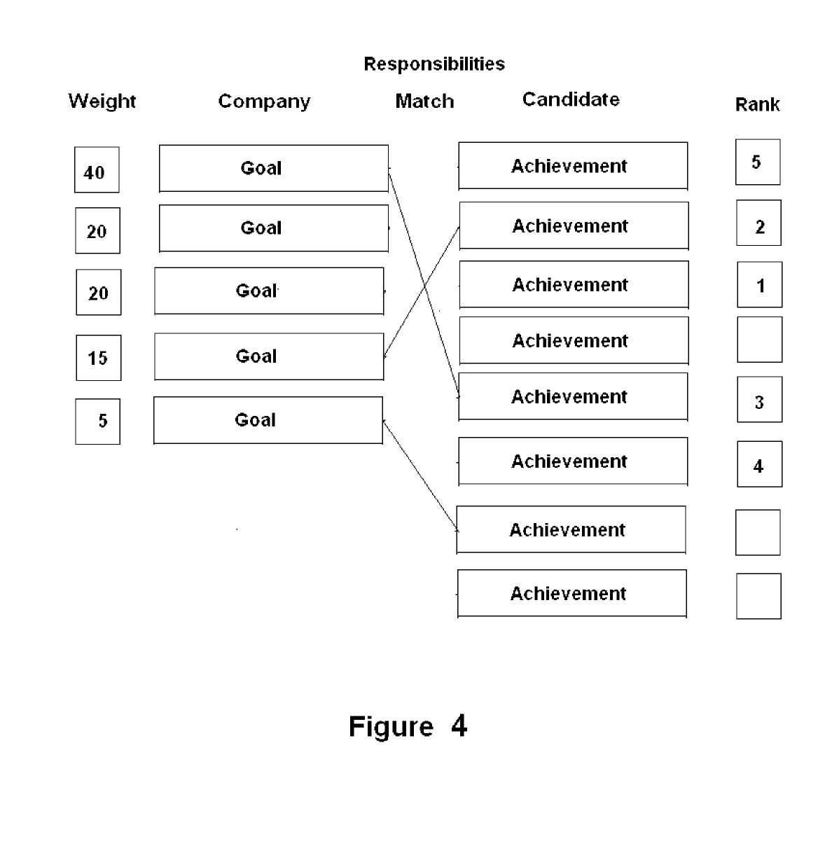

The system 1 calculates scores of candidates against requirement criteria of a position. The goals of the company are matched against the achievements of the candidate. Up to 3 goals are prioritized by the company and compared to up to 5 summary achievements by the candidate. Weights are assigned by Company to goals they defined, which are then compared with the achievements summarized by the candidates over latest 10 years of their career. This is FIG. 4 where Achievements matched with goals are weighted and scored.

Among the 15 responsibilities of the company, 5 are selected by calculating the composite weights between priority of each goal and their selected responsibility. These 5 responsibilities are compared to up to 8 proficient responsibilities/skills cited by the candidate over the last 10 years of their career. These responsibilities/skills are prioritized and weights are assigned. The responsibilities are matched, weighted and scored.

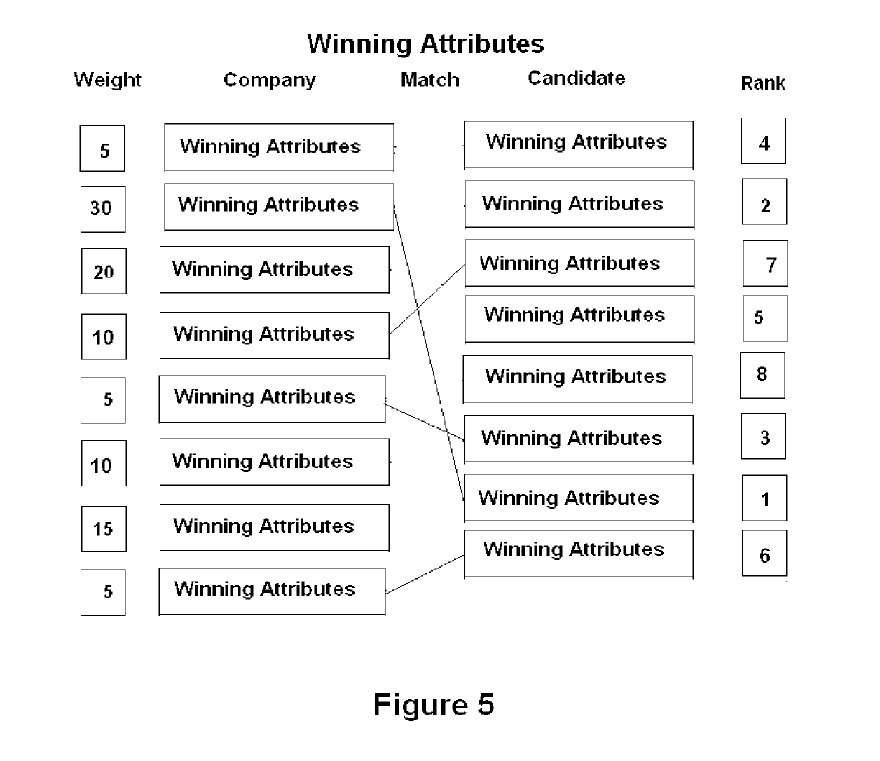

The up to 8 winning attributes are prioritized with weights assigned by Company or the System 1 to each attribute. The attributes are matched, weighted and scored as shown in FIG. 5.

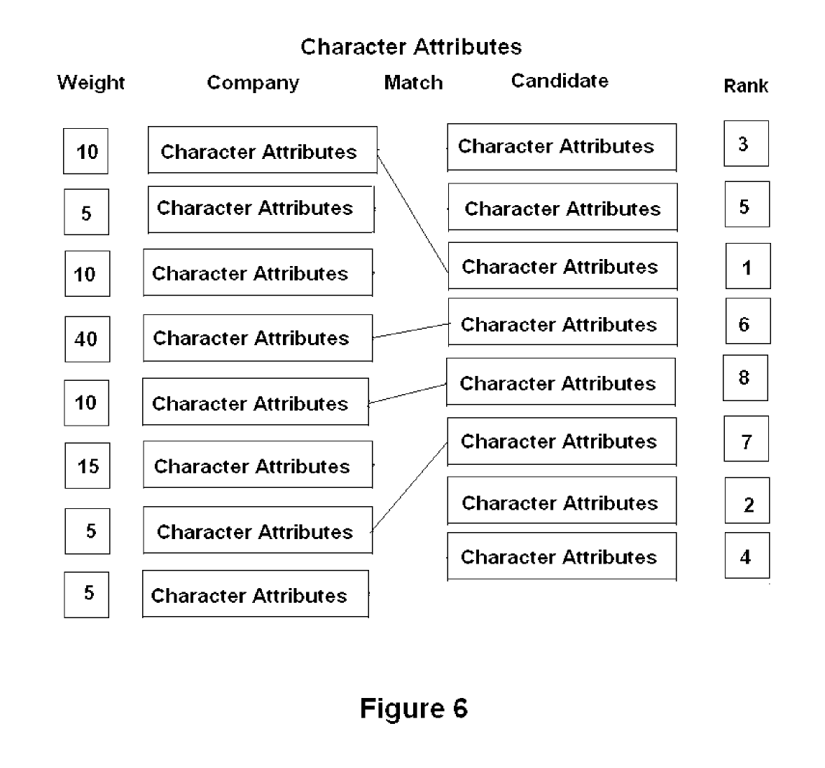

The up to 8 character attributes are prioritized with weights assigned by Company or the System 1 to each attribute. The attributes are matched, weighted and scored. FIG. 6 is an example of the character attributes being weighted and scored.

Upon matching and calculating the 3 categories above, a composite score is calculated for each candidacy, against the requirements of a position, as defined by the recruiting company

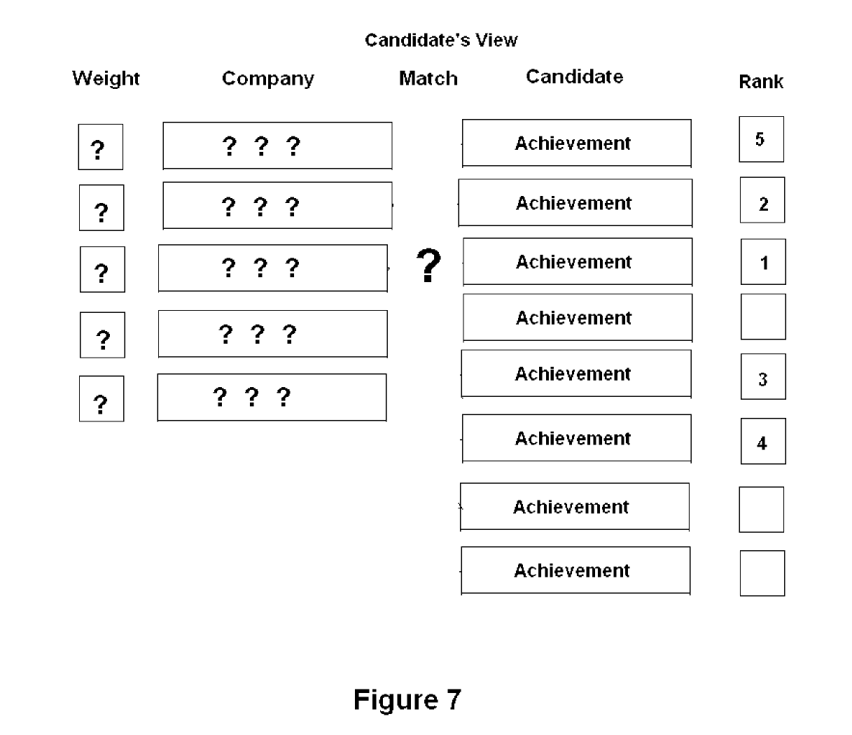

As shown in FIG. 7, the system employs various security measures. These security measures are embedded in the structure and processing of data within the system, as follows. For the company, the candidates do not know the required priorities and the company assigned weights of each goal, the candidates do not know weights attached to individual responsibilities, which are skewed by weights assigned by Company to corresponding goals. For the candidates, the candidates are required to select and prioritize 5 achievements over their career, as they develop their resumes, the candidates are required to select and prioritize 5 most proficient responsibilities over their career. These 5 are unlikely to hit the preferred/weighted few, amongst the larger number of responsibilities posted for a position. This is for candidates joining the system 1, and not applying for a specific position.

The system 1 uses artificial intelligence using effectively 3 learning scenarios.

Data Enrichment where the system 1 does a front end (check, if n/a . . . ), enter free-form, system checks back-end (via fuzzy logic . . . ).

The system 1 will identify the Most Common Practices by collecting all of the specifications for same/similar positions using a fuzzy logic match to create a ‘most commonly used’ search criteria/spec.

The system 1 will identify the Best Practices by following up with the candidates after joining the companies. It will adjust original specification to improve the system 1. The system 1 will create ‘best practice’ specification using value add by company and candidate validation.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A data processing system for recruiting employees comprising:
a) having a company input data,
a) having a candidate input data;
b) comparing the company's data versus the candidate's data;
d) assigning a weight to company's data; and
e) calculating a score based on the weights and comparison of the company's data and candidate's data.

2. A system according to claim 1 where said company data consists of a set of goals, responsibilities, personal attributes and winning attributes.

3. A system according to claim 1 where said candidate's data consists of a set of achievements, experience/responsibilities, personal attributes and winning attributes.

4. A system according to claim 1 where said model identification step uses artificial intelligent to review said data.

5. A system according to claim 1 where said model identification step uses fuzzy logic to review said data.

6. A system according to claim 2 where no more than 3 goals are entered.

7. A system according to claim 2 where no more than 5 responsibilities and professional inputs are entered.

8. A system according to claim 2 where no more than 8 personal attributes are entered.

9. A system according to claim 3 where no more than 5 achievements are entered.

10. A system according to claim 3 where no more than 8 experience/responsibilities are entered.

11. A system according to claim 3 where no more than 8 personal attributes are entered.

12. A system according to claim 1 where said company data consists of a set of goals, responsibilities, personal attributes and winning attributes, and where said candidate's data consists of a set of achievements, experience/responsibilities, personal attributes and winning attributes.

13. A system according to claim 12 where no more than 3 goals are entered.

14. A system according to claim 12 where no more than 5 responsibilities are entered.

15. A system according to claim 12 where no more than 8 personal qualifications are entered.

16. A system according to claim 12 where no more than 3 achievements are entered.

17. A system according to claim 12 where no more than 8 experience/responsibilities are entered.

18. A system according to claim 12 where no more than 8 personal attributes are entered.

19. A system according to claim 12 where the personal attributes required by a company are compared with the personal attributes profiled by a candidate.

20. A system according to claim 12 where the responsibilities required by a company are compared with experience/responsibilities of a candidate.

21. A system according to claim 12 where the goals are compared with the achievements.

22. A system according to claim 1 which is accessed over a network.

23. A system according to claim 2 where no more than 8 winning attributes are entered.

24. A system according to claim 12 where no more than 8 winning attributes are entered.

25. A system according to claim 3 where no more than 8 winning attributes are entered.

26. A system according to claim 21 where the winning attributes required by a company are compared with the winning attributes described by a candidate.
